(19) United States
(12) Patent Application Publication
(10) Pub. No.: US 2014/0191632 A1
(43) Pub. Date: Jul. 10, 2014

(54) SYNCHRONIZATION APPARATUS FOR MOVING FURNITURE PARTS

(71) Applicant: Julius Blum GmbH, Hoechst (AT)

(72) Inventor: Markus STEINHAUSER, Rankweil (AT)

(73) Assignee: Julius Blum GmbH, Hoechst (AT)

(21) Appl. No.: 14/205,515

(22) Filed: Mar. 12, 2014

Related U.S. Application Data
(63) Continuation of application No. PCT/AT2012/000221, filed on Aug. 24, 2012.

(30) Foreign Application Priority Data
Sep. 20, 2011 (AT) 1356/2011

(51) Int. Cl. E05D 15/46

(52) U.S. Cl. CPC E05D 15/46
USPC 312/110; 29/896.92

(57) ABSTRACT

Synchronization apparatus (6) having at least two actuating apparatuses (100, 200) for moving a movable furniture part (3) and having a synchronization rod (5) for synchronizing the movement of the at least two actuating apparatuses (100, 200), wherein a first end region of the synchronization rod (5) can be connected to a first rotary part (102) of the first actuating apparatus (100), and a second end region of the synchronization rod (5) can be connected to a second rotary part (202) of the second actuating apparatus (200), characterized in that at least one rotary part (202) of the actuating apparatuses (100, 200) has a sprung contact-pressure part (207) which bears against the end face of the synchronization rod (5).

The present invention concerns a synchronization apparatus having at least two actuating devices for moving a moveable furniture part and a synchronization rod for synchronizing the movement of the at least two actuating devices, wherein a first end region of the synchronization rod can be connected to a first rotary portion of the first actuating device and a second end region of the synchronization rod can be connected to a second rotary portion of the second actuating device.

In addition the invention concerns an article of furniture having at least one synchronization apparatus of the kind to be described and a method of mounting a synchronization rod which is provided for synchronization of a movement of two actuating devices to be mounted in or to an article of furniture.

WO 2006/113953 A1 to the present applicant describes a synchronization apparatus of the general kind set forth, wherein two actuating devices each have a rotatably mounted portion, which portions can be non-rotatably connected together by way of a synchronization rod. In a first mounting step, the two actuating devices are pre-mounted in an article of furniture, in a subsequent mounting step the synchronization rod can be connected to the pre-mounted rotatable portions of the actuating devices. The synchronization rod can provide for a synchronous rotary movement of the two actuating devices and thus a harmonic movement of a moveable furniture part. For making the non-rotatable connection to the rotatable portions, the synchronization rod has a non-circular cross-section received in a corresponding recess in the rotatable portions. That requires additional machining of the synchronization rod.

An object of the present invention is to provide a synchronization apparatus of the general kind set forth in the opening part of the specification, while avoiding the above-mentioned disadvantage, while the aim is to permit easy assembly and play-free connection of the synchronization rod relative to the two rotary portions.

According to the invention, that is achieved by the features of claim 1. Further advantageous configurations of the invention are recited in the appendant claims.

According to the invention, it is therefore provided that at least one rotary portion of the actuating devices has a spring-loaded pressure portion bearing against the end of the synchronization rod.

The spring-loaded pressure portion produces a contact pressure force to hold the synchronization rod in a biased play-free condition between the two opposite rotary portions of the two actuating devices with a predetermined holding force in a direction extending in the longitudinal direction of the synchronization rod, wherein a comparatively weak spring being in principle sufficient for that purpose.

For transmission of the torque between the two rotary portions of the actuating devices disposed in opposite relationship on the article of furniture, it can be provided that the spring-loaded pressure portion engages in positively locking relationship into a recess deviating from a circular shape in the end of the synchronization rod. In that respect, it can be provided that at least one end region of the synchronization rod has a non-circular cross-section, and the rotary portion of the actuating device has a receiving sleeve adapted at least portion-wise to the outside contour of the end region of the synchronization rod.

In a possible configuration of the invention it can be provided that the receiving sleeve or at least the bottom of the receiving sleeve, that bears against the front face of the synchronization rod, is in the form of a spring-loaded pressure portion. In principle it can be sufficient if the spring-loaded pressure portion is formed in one piece by the end of a spring.

Arranging a spring-loaded pressure portion on a rotary portion of the actuating device has several advantages. More specifically, it can be provided that the synchronization rod is adapted to be invariable in length, wherein it is preferably provided that the synchronization rod is of the same cross-section over the entire length and wherein it is particularly preferably provided that the synchronization rod is in the form of a hollow profile member of the same inside diameter over the entire length.

In other words, the synchronization rod can be formed for example from a simple extruded profile member of metal—for example aluminum—which is individually cut to the appropriate length on site. In that way it is possible to provide for optimum compensation of the tolerances occurring. In that respect, it is possible to completely dispense with any additional machining of that profile member.

The article of furniture according to the invention is characterized by at least one synchronization apparatus of the kind in question. In that case, the two actuating devices can be provided for moving a furniture flap mounted moveably in respect of height relative to a furniture carcass. It can however also be possible for the two actuating devices to be adapted to move a drawer which is supported displaceably relative to a furniture carcass, for example for stabilizing the running characteristic thereof to prevent lateral tilting of the drawer relative to a furniture carcass.

In principle the synchronization apparatus can be used wherever a rotary movement of two actuating devices is to be synchronized, for example therefore also for synchronously triggering so-called Touch-Latch devices for ejecting moveable furniture parts from the closed end position. That Touch-Latch function makes it possible to eject moveable furniture parts by a manual pressing or pulling applied on the moveable furniture part.

The method according to the invention of mounting a synchronization rod which is provided for synchronization of a movement of two actuating devices to be mounted in or to an article of furniture and wherein the actuating devices respectively have a rotary portion for the movement of a moveable furniture part, is characterized in that
the two actuating devices are mounted in or to an article of furniture, and
the synchronization rod is pressed inclinedly relative to a notional connecting line (X) between the rotary portions of the actuating devices against a spring-loaded pressure portion of a rotary portion, and
the synchronization rod is pivoted into the notional connecting line (X), and
then, under a spring action, the spring-loaded pressure portion is pushed towards the oppositely disposed rotary portion and non-rotatably connected thereto by way of the synchronization rod.

Further details and advantages of the invention will be described by reference to the specific description hereinafter. In the drawing:

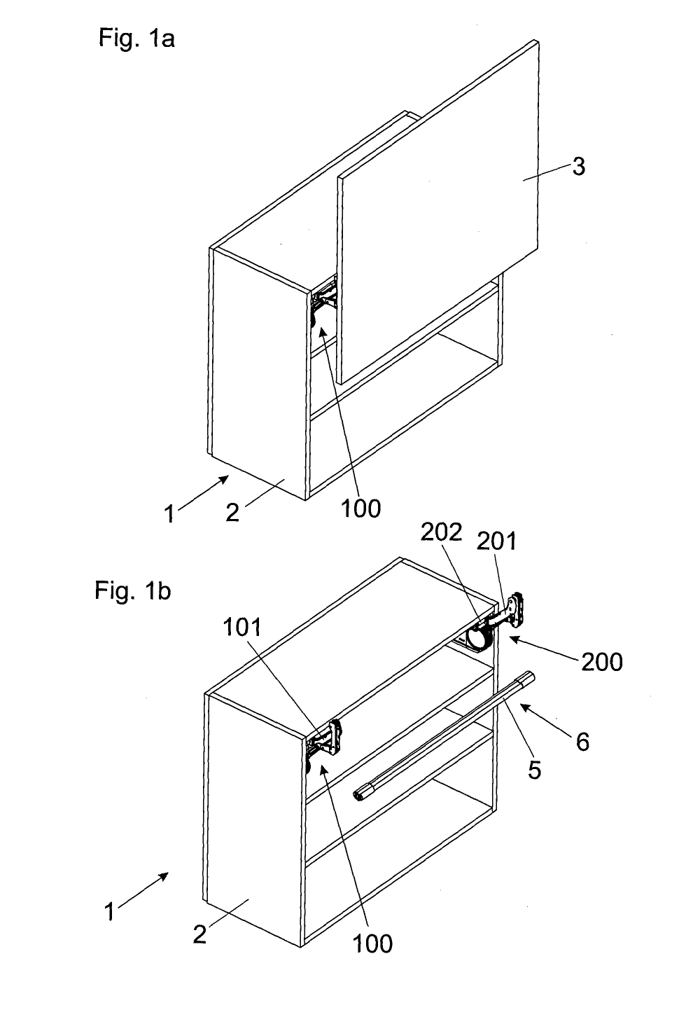

FIGS. 1a and 1b show perspective views of an article of furniture with a furniture flap moveable in respect of height and the synchronization apparatus to be mounted to the article of furniture,

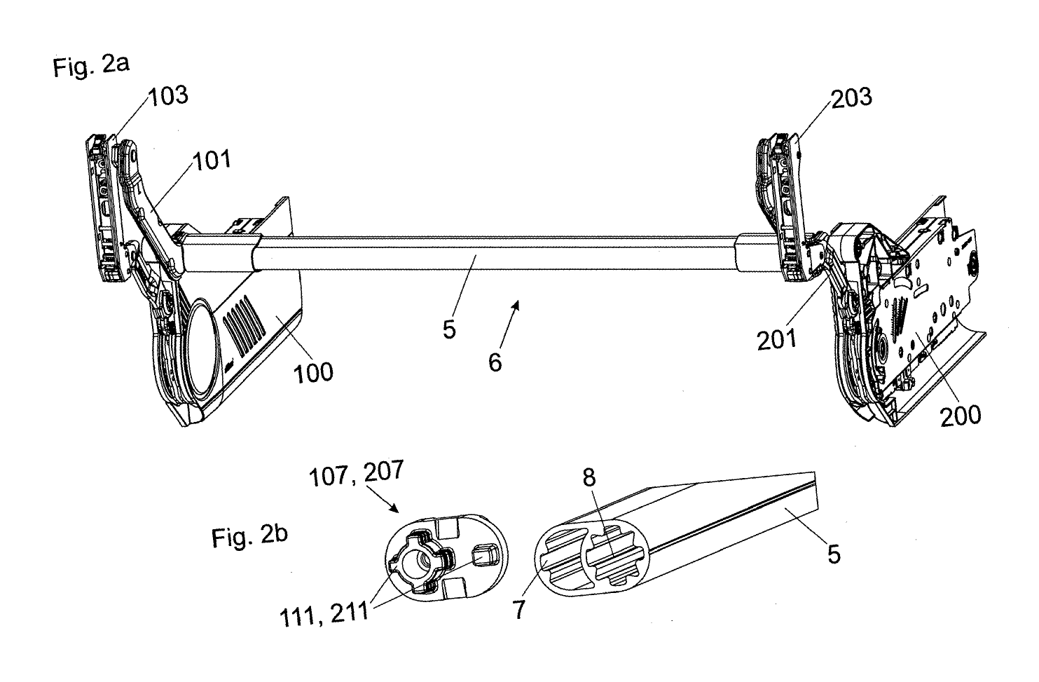

FIGS. 2a and 2b show a perspective view of an embodiment of a synchronization apparatus as well as a view of a pressure portion with an end region of the synchronization rod,

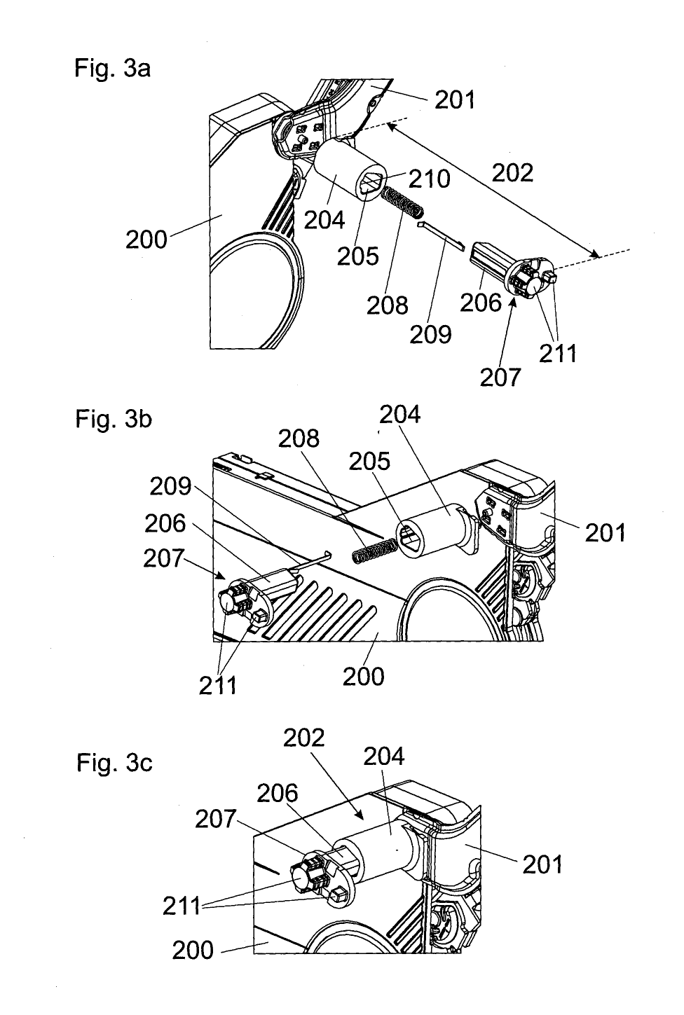

FIGS. 3a-3c show various views of the rotary portion of an actuating device,

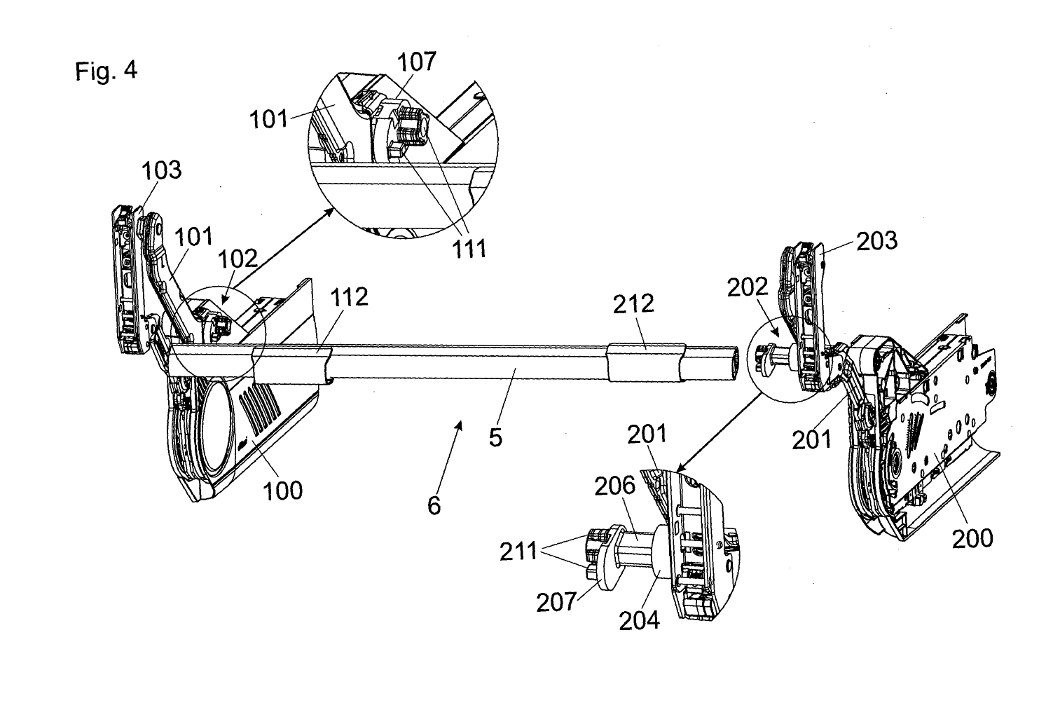

FIGS. 4-7 show mounting of the synchronization rod in successive mounting steps,

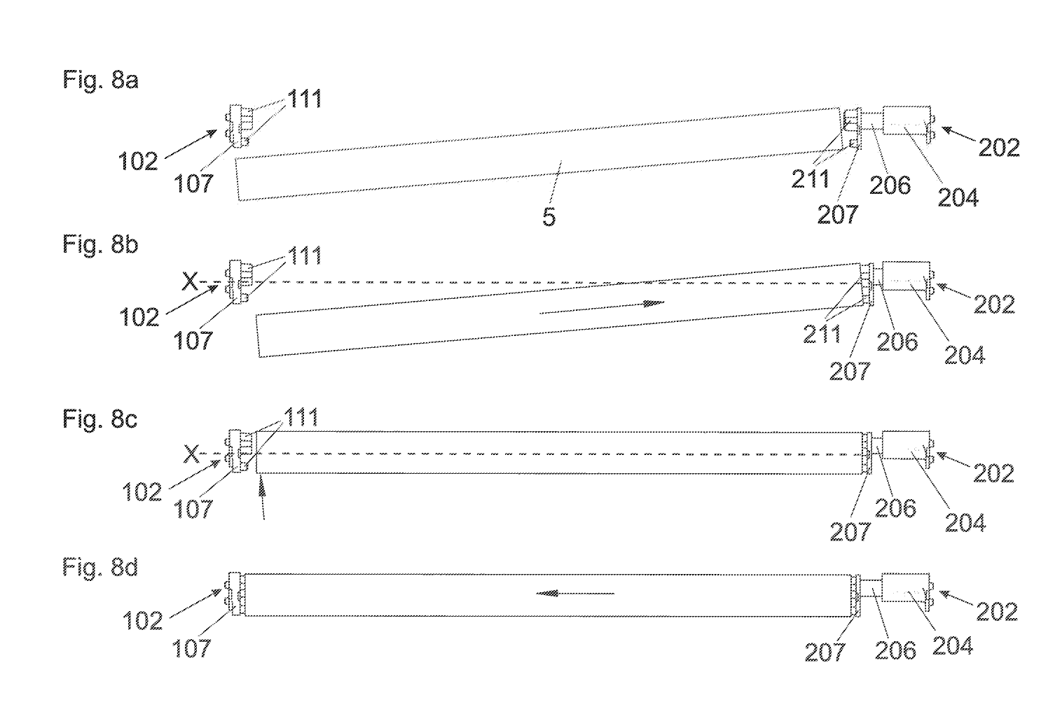

FIGS. 8a-8d show diagrammatic views illustrating mounting of the synchronization rod relative to the rotary portions of the actuating devices, and

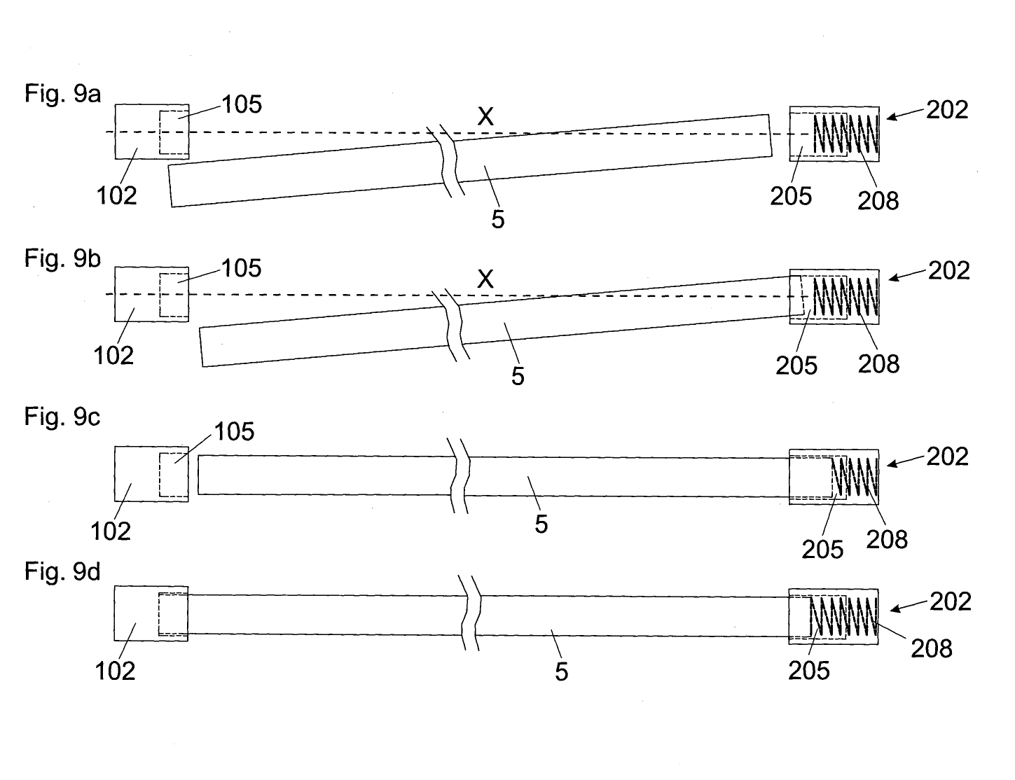

FIGS. 9a-9d show mounting of the synchronization rod to rotary portions in a simplified embodiment.

FIG. 1a shows an article of furniture 1 having a furniture carcass 2 and a flap 3 which is mounted moveably in respect of height relative to the furniture carcass 2 by way of actuating devices 100, 200. The flap 3 is removed from the view in FIG. 1 b so that the actuating devices 100, 200 mounted at opposite side walls are visible. The two actuating devices 100, 200 together with a synchronization rod 5 form a synchronization apparatus 6 for moving the flap 3. In the illustrated embodiment, the two actuating devices 100, 200 respectively have at least one actuating arm 101, 201 pivotable preferably about a horizontal axis, respectively to be connected to the flap 3. A respective rotary portion 102, 202 is motionally coupled to the actuating arms 101, 202, wherein the rotary portion 102 of the left-hand actuating device 100 is not visible in view shown in FIG. 1b. The synchronization rod 5 which is in the form of a torsion shaft is provided for synchronization of the movement of the two actuating devices 100, 200 so that coupled synchronous rotary movement of the two rotary portions 102, 202 is also produced. Preferably, the synchronization rod 5 extends substantially horizontally in the position of use.

FIG. 2a shows a perspective view of the synchronization apparatus 6, wherein the two actuating devices 100, 200 are to be fixed at mutually opposite sides in or to an article of furniture 1. The actuating devices 100, 200 respectively have spring devices (not visible here) which are provided to pressurize the actuating arms 101, 201 towards the opening direction and thus to compensate for the weight of the flap 3. At least one of the actuating devices 100, 200 can also have an electric motor for driving an actuating arm 101, 201, alternatively or supplemental to a spring device. The pivotal movement of the two actuating arms 101, 201 can be synchronized by the synchronization rod 5. Arranged on the actuating arms 101, 201 are respective fitment portions 103, 203 which are to be respectively connected to the flap 3.

FIG. 2a shows a perspective view of a spring-loaded pressure portion 107, 207 with an end region of the synchronization rod 5. In the assembled condition, the pressure portion 107, 207 engages with the projections 111, 211 into recesses 7, 8 differing from a circular shape in the front face of the synchronization rod 5. The illustrated construction makes it possible to provide a reliable positively locking connection for the transmission of torque.

FIG. 3a shows an exploded view of part of the actuating device 200 with the actuating arm 201 pivotably mounted thereto. Connected to the actuating arm 201 is a rotary portion 202, so the rotary portion 202 also rotates upon a pivotal movement of the actuating arm 201. The rotary portion 202 includes a receiving sleeve 204 with a non-circular opening 205 provided to receive a shaft 206 corresponding thereto of a spring-loaded pressure portion 207. The spring-loaded pressure portion 207 is biased with respect to the receiving sleeve 204 by a spring 208 so that the pressure portion 207 is limitedly displaceable between two end positions in a direction extending in the longitudinal direction of the synchronization rod 5. The pressure portion 207 projects beyond the receiving sleeve 204 in the rest position and can be pressed axially into the receiving sleeve 204 in opposition to the spring action. A holding element 209 is operative between the pressure portion 207 and the receiving sleeve 204, the holding element 209 limiting the outward extension movement of the pressure portion 207 relative to the receiving sleeve 204 so that the pressure portion 207 is not pressed completely out of the receiving sleeve 204 by the force of the spring 208. The holding element 209 is arranged in a groove 210 in the receiving sleeve 204 and at its end regions has projections which engage on the one hand between the actuating arm 201 and the receiving sleeve 204 and on the other hand on the spring-loaded pressure portion 207. The pressure portion 207 is provided with projections 211 which, in the assembled position, engage into a recess 7, 8 (FIG. 2b) differing from a circular shape, in the end of the synchronization rod 5.

FIG. 3b shows another perspective view of the portion shown in FIG. 3a, the pressure portion 207 being connected to the holding element 209. FIG. 3c shows the mounted position of the rotary portion 202, wherein the shaft 206 of the pressure portion 207 is mounted displaceably within the receiving sleeve 204 and projects beyond same. Starting from that position, the pressure portion 207 can be pressed into the receiving sleeve 204 in opposition to the force of the spring 208. FIG. 3c shows the delivery condition of the rotary portion 202 from the factory.

FIG. 4 shows the synchronization apparatus 6 with the two actuating devices 100, 200 which are to be fixed to an article of furniture 1 in a first mounting step. The enlarged view shows the two rotary portions 102, 202 of the actuating devices 100, 200 respectively. Mounting of the synchronization rod 5 is also possible when the two actuating devices 100, 200 are already pre-mounted to the article of furniture 1, with the rotary portions 102, 202. In the illustrated embodiment, the rotary portion 102 of the left-hand actuating device 100 has a non-sprung pressure portion 107 while the rotary portion 202 of the right-hand actuating device 200 is provided with a spring-loaded pressure portion 207 which can be pushed in with the shaft 206 in the direction of the receiving sleeve 204 so that the internal spacing between the two rotary portions 102, 202 can be temporarily increased by pushing in the spring-loaded pressure portion 207. Cover portions 112, 212 are displaceably mounted to the synchronization rod 5, which after mounting of the synchronization rod 5 has been effected can be positioned over the pressure portions 107, 207.

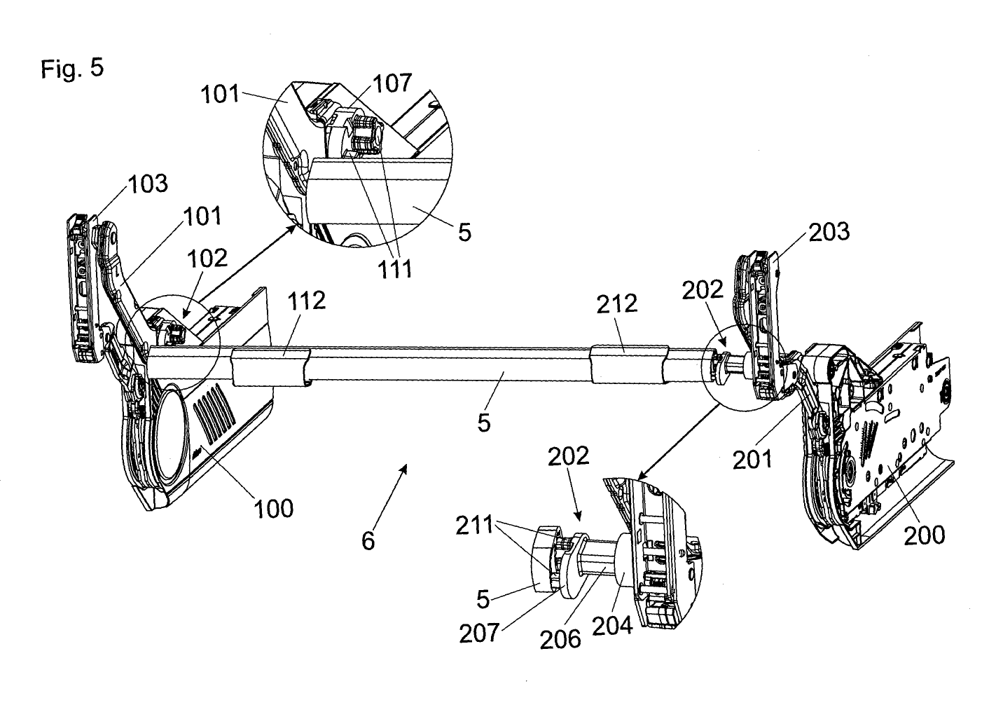

FIG. 5 shows the further mounting procedure for the synchronization rod 5 which can be slightly inclinedly pushed with the right-hand end region on to the two projections 211 of the spring-loaded pressure portion 207. The left-hand end region of the synchronization rod 5 is initially not yet connected to the non-sprung pressure portion 107.

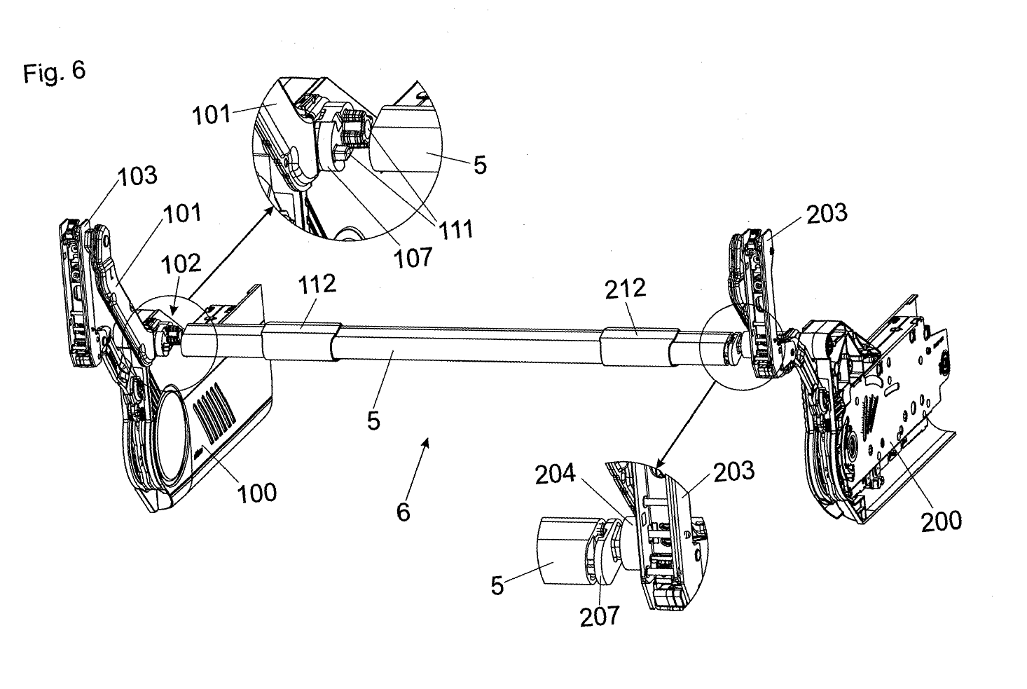

FIG. 6 shows a subsequent mounting step, wherein the right-hand spring-loaded pressure portion 207 can be pushed by a predetermined travel distance into the receiving sleeve 204 against the force of the spring 208 by manually applying pressure to the synchronization rod 5. The synchronization rod 5 is now disposed on the notional connecting line between the two rotary portions 102, 202 of the two actuating devices 100, 200.

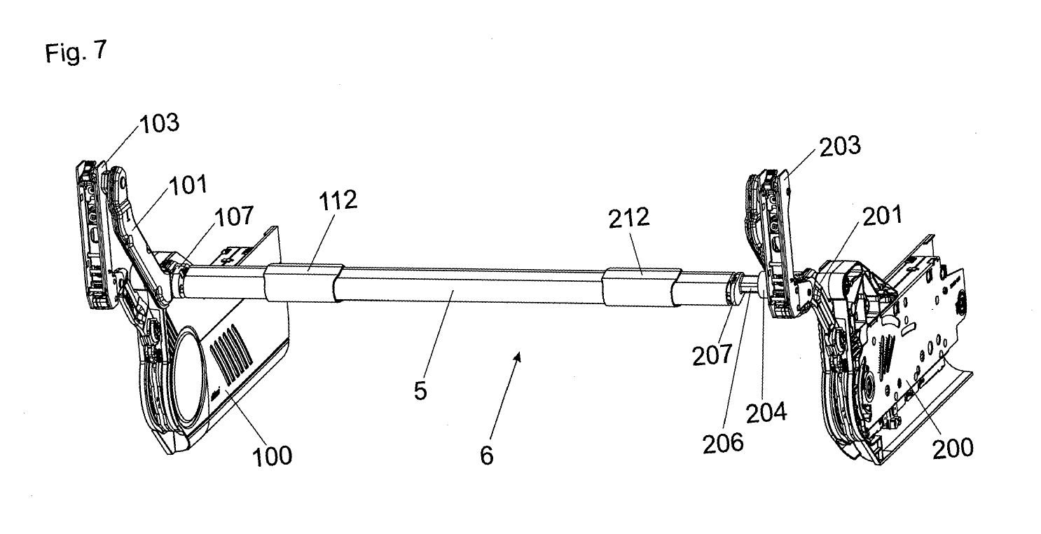

FIG. 7 shows the synchronization rod 5 connected to the pressure portions 107, 207. Now, starting from FIG. 6, pressure is no longer applied to the synchronization rod 5 by the fitter, whereupon the spring-loaded pressure portion 207 with the shaft 206 moves out again due to the expanding spring 208 so that the left-hand end of the synchronization rod 5 is pushed on to the projections 111 of the right-hand non-sprung pressure portion 107. The movement of the two actuating arms 101, 201 is now synchronized by a positively locking relationship. The two cover portions 112, 212 can then be pushed onto the two pressure portions 107 and 207.

FIGS. 8a-8c show highly diagrammatic views illustrating mounting of the synchronization rod 5 relative to the two rotary portions 102, 202 of the two oppositely disposed actuating devices 100, 200. As shown in FIG. 8a, the two actuating devices 100, 200 are pre-mounted with their rotary portions 102, 202 to an article of furniture 1, whereupon the synchronization rod 5 is pressed inclinedly relative to a notional connecting line (X) between the rotary portions 102, 202 against the spring-loaded pressure portion 207 of the right-hand rotary portion 202, in which case the projections 211 of the spring-loaded pressure portion 207 are received in the hollow profile member of the synchronization rod 5. In FIG. 8b, the synchronization rod 5 is pressed manually in the direction indicated by the arrow, in which case the pressure portion 207 with the shaft 206 is pressed against the spring force in the direction of the receiving sleeve 204. As shown in FIG. 8c, the synchronization rod 5 is pivoted into the notional connecting line (X) between the two rotary portions 201, 202. As shown in FIG. 8d, the synchronization rod 5 is displaced towards the left in the direction indicated by the arrow by the expanding spring 208 (FIG. 3a), in which case the projections 111 of the left-hand non-sprung pressure portion 107 engage into the end of the synchronization rod 5.

FIGS. 9a-9d also show highly diagrammatic forms of a simplified embodiment of the rotary portions 201, 202 of the actuating devices 100, 200. The left-hand rotary portion 102 has an opening 105, preferably of non-circular cross-section, while a spring 208 is mounted in the opening 205 of the right-hand rotary portion 202. Referring to FIG. 9a, the rotary portions 102, 202 are already pre-mounted to an article of furniture 1, whereupon the synchronization rod 5 is pressed inclinedly relative to a notional connecting line (X) between the two rotary portions 201, 202 against a spring-loaded pressure portion 207 of the rotary portion 202. In the illustrated embodiment, the spring-loaded pressure portion 207 of the rotary portion 202 is formed in one piece by the end of the spring 208, the synchronization rod 5 being pushed into the opening 205 by manually applying pressure (FIG. 9b). As shown in FIG. 9c, the synchronization rod 5 was pivoted into the notional connecting line (X), the spring 208 being compressed while the manual force is maintained. The manual pressure is now removed from the synchronization rod 5 so that the left-hand end region of the synchronization rod 5 can move into the opening 105 provided in the left-hand rotary portion 102 due to expansion of the spring 208 and the synchronization rod 5 is held in a play-free manner between the two rotary portions 102, 202. Transmission of the torque can be effected by way of a positively locking connection, as already described above.

The present invention is not limited to the illustrated embodiments but includes or extends to all variants and technical equivalents which can fall within the scope of the appended claims. The positional references adopted in the description like for example up, down, left, right and so forth are also related to the directly described and illustrated Figure and are to be appropriately transferred to the new position upon a change in position. It is preferably provided that the pressure portion 207 is pre-mounted to or in the article of furniture 1 and is motionally coupled to the actuating arm 201 so that upon a pivotal movement of the actuating arm 201, the pressure portion 207 also rotates therewith, in which case then the synchronization rod 5 can be connected to the pressure portion 207 which is already pre-mounted. For easy mounting of the synchronization rod 5, it can be provided that the rotary portion 202 to which the pressure portion 207 is fitted is preferably mounted rotatably exclusively about an axis of rotation.

1. A synchronization apparatus having at least two actuating devices for moving a moveable furniture part, and a synchronization rod for synchronizing the movement of the at least two actuating devices, wherein a first end region of the synchronization rod can be connected to a first rotary portion of the first actuating device and a second end region of the synchronization rod can be connected to a second rotary portion of the second actuating device, wherein at least one rotary portion of the actuating devices has a spring-loaded pressure portion bearing against the end of the synchronization rod.

2. The synchronization apparatus according to claim 1, wherein the pressure portion engages in positively locking relationship into a recess deviating from the circular shape in the end of the synchronization rod.

3. The synchronization apparatus according to claim 2, wherein at least one end region the synchronization rod has a non-circular cross-section and the rotary portion of the actuating device has a receiving sleeve adapted at least portion-wise to the outside contour of the end region of the synchronization rod.

4. The synchronization apparatus according to claim 3, wherein the receiving sleeve or at least the bottom of the receiving sleeve, that bears against the end of the synchronization rod (5), is in the form of the spring-loaded pressure portion.

5. The synchronization apparatus according to claim 1, wherein the pressure portion is formed in one piece by the end of a spring.

6. The synchronization apparatus according to claim 1, wherein the synchronization rod is adapted to be invariable in length, wherein it is preferably provided that the synchronization rod is of the same cross-section over the entire length and wherein it is particularly preferably provided that the synchronization rod is in the form of a hollow profile member of the same inside diameter over the entire length.

7. The synchronization apparatus according to claim 1, wherein the pressure portion is mounted displaceably between two end positions relative to the rotary portion of the actuating device in a direction extending in the longitudinal direction of the synchronization rod.

8. The synchronization apparatus according to claim 1, wherein the rotary portion of the actuating device has a receiving sleeve, wherein the pressure portion is supported in the receiving sleeve and projects beyond same.

9. The synchronization apparatus according to claim 8, wherein the pressure portion) is biased by a spring in relation to the receiving sleeve.

10. The synchronization apparatus according to claim 1, wherein operative between the pressure portion and the receiving sleeve is a holding element which limits the outward extension movement of the pressure portion relative to the receiving sleeve.

11. The synchronization apparatus according to claim 1, wherein the synchronization rod can also be connected to the rotary portions of the actuating devices when the rotary portions are already pre-mounted to or in an article of furniture.

12. The synchronization apparatus according to claim 1, wherein in the assembled condition, the synchronization rod is non-rotatably connected to the rotary portions of the actuating devices.

13. An article of furniture comprising a moveable furniture part, wherein a movement of the moveable furniture part can be synchronized by a synchronization apparatus according to claim 1.

14. The article of furniture according to claim 13, wherein the moveable furniture part is a furniture flap which is moveable upwardly relative to a furniture carcass by the actuating devices or the moveable furniture part is a drawer which is mounted displaceably relative to a furniture carcass by the actuating devices.

15. A method of mounting a synchronization rod which is provided for synchronization of a movement of two actuating devices to be mounted in or to an article of furniture, wherein the actuating devices respectively have a rotary portion for the movement of a moveable furniture part, wherein
the two actuating devices are mounted in or to an article of furniture, and
the synchronization rod (5) is pressed inclinedly relative to a notional connecting line (X) between the rotary portions of the actuating devices against a spring-loaded pressure portion of a rotary portion, and
the synchronization rod is pivoted into the notional connecting line (X), and
then, under a spring action, the spring-loaded pressure portion is pushed towards the oppositely disposed rotary portion and non-rotatably connected thereto by way of the synchronization rod.
